(19) United States
(12) Patent Application Publication
(10) Pub. No.: US 2026/0032799 A1
(43) Pub. Date: Jan. 29, 2026

(54) METHOD FOR CONTROLLING LIGHTING EFFECT OF SPLICED LAMP, DEVICE, APPARATUS, AND MEDIUM

(71) Applicant: Shenzhen Intellirocks Tech. Co., Ltd., Shenzhen (CN)

(72) Inventors: Shijie LIU, Shenzhen (CN); Wenlong WU, Shenzhen (CN)

(21) Appl. No.: 19/342,551

(22) Filed: Sep. 27, 2025

Related U.S. Application Data
(63) Continuation of application No. PCT/CN2024/095282, filed on May 24, 2024.

(30) Foreign Application Priority Data
Jun. 2, 2023 (CN) 2023106488713

(51) Int. Cl. H05B 47/175; F21S 2/00

(52) U.S. Cl. CPC H05B 47/196; F21S 2/005

(57) ABSTRACT

The present application relates to a method for controlling a lighting effect of a spliced lamp, as well as a device, an apparatus, and a medium. The method comprises: displaying a spatial topological graph of the spliced lamp in an effect editing region of a graphical user interface; displaying a visual marker of a motion base point of the spliced lamp in the effect editing region in an initialized manner; updating the motion base point according to the latest position of the visual marker relative to the spatial topological graph; driving the spliced lamp to play a lighting effect by using a lighting effect playing instruction that is generated on the basis of the motion base point, such that a mapping position of the motion base point in the physical space serves as a benchmark reference point of a motion process of the lighting effect.

### CROSS-REFERENCE TO RELATED APPLICATIONS

This application is a continuation application of International Patent Application No. PCT/CN2024/095282, filed on May 24, 2024, which claims the priority of Chinese Patent Application No. 2023106488713, filed on Jun. 2, 2023, both of which are herein incorporated by reference in their entirety.

### TECHNICAL FIELD

The present disclosure pertains to the technical field of illumination, and particularly relates to a method for controlling a lighting effect of a spliced lamp, as well as a device and an apparatus that correspond thereto, and a computer-readable storage medium.

### BACKGROUND

With functions of showing information, decorating atmosphere, etc., lighting effect apparatuses have been widely used. The intelligence level thereof is increasingly higher, and the functions thereof are constantly developing to meet different needs. A typical lighting effect apparatus is formed by splicing a plurality of lamp body units together, and thus is a spliced lamp. The plurality of lamp body units of the spliced lamp are generally spread along a plane to form a planar array. When there is a need to play a lighting effect that is presented through the spliced lamp, the lamp body units can be used as basic control units and put under corresponding light-emitting control. As the plurality of lamp body units coordinate with each other, the lighting effect is played.

In the traditional technology, considering the difficulty in controlling multi-point light emission, in order to play corresponding lighting effects, lighting effect playing instructions are first compiled according to expected lighting effects; through the lighting effect playing instructions, a lighting effect apparatus is controlled to play the corresponding lighting effects; in this way, ordinary users only need to select and apply the lighting effect playing instructions in a foolproof manner, which is relatively fast and efficient.

In practice, a limited number of lighting effect playing instructions not only deprive the users of flexibility in selection, but also restrict the spliced lamp from fulfilling product functions. The lamp body units of the spliced lamp have potential to expand the product functions in terms of diverse tones, diverse spliced shapes, and diverse lighting effect motion modes. To tap into this potential, the industry needs to engage in sustained and in-depth exploration.

### SUMMARY

It is an objective of the present application to provide a method for controlling a lighting effect of a spliced lamp, as well as a device and an apparatus that correspond thereto, and a computer-readable storage medium.

According to one aspect of the present application, there is provided a method for controlling a lighting effect of a spliced lamp, comprising:
displaying a spatial topological graph of the spliced lamp in an effect editing region of a graphical user interface, wherein the spatial topological graph represents a spatial position layout of lamp body units of the spliced lamp in a physical space;
displaying a visual marker of a motion base point of the spliced lamp in the effect editing region in an initialized manner;
updating the motion base point according to the latest position of the visual marker relative to the spatial topological graph in response to a repositioning instruction that acts on the visual marker;
driving the spliced lamp to play a lighting effect by using a lighting effect playing instruction that is generated on the basis of the motion base point, such that a mapping position of the motion base point in the physical space serves as a benchmark reference point of a motion process of the lighting effect.

According to another aspect of the present application, there is provided a device for controlling a lighting effect of a spliced lamp, comprising:
a topology display module, configured to display a spatial topological graph of the spliced lamp in an effect editing region of a graphical user interface, wherein the spatial topological graph represents a spatial position layout of lamp body units of the spliced lamp in a physical space;
a base point display module, configured to display a visual marker of a motion base point of the spliced lamp in the effect editing region in an initialized manner;
a base point setting module, configured to update the motion base point according to the latest position of the visual marker relative to the spatial topological graph in response to a repositioning instruction that acts on the visual marker;
a lighting effect playing module, configured to drive the spliced lamp to play a lighting effect by using a lighting effect playing instruction that is generated on the basis of the motion base point, such that a mapping position of the motion base point in the physical space serves as a benchmark reference point of a motion process of the lighting effect.

According to another aspect of the present application, there is provided an apparatus for controlling a lighting effect of a spliced lamp, comprising a central processing unit and a memory, wherein the central processing unit is used to call and run computer programs stored in the memory to execute steps of the method for controlling a lighting effect of a spliced lamp.

According to another aspect of the present application, there is provided a non-volatile readable storage medium, in which computer programs implemented according to the method for controlling a lighting effect of a spliced lamp are stored in the form of computer-readable instructions, wherein when the computer programs are called and executed by the computer, the steps included in the method are executed.

According to another aspect of the present application, there is provided a computer program product, comprising computer programs/instructions, wherein when executed by a processor, the computer programs/instructions implement steps of the method for controlling a lighting effect of a spliced lamp in any embodiment of the present application.

### BRIEF DESCRIPTION OF THE DRAWINGS

FIG. 1 is a structure diagram of a spliced lamp in an embodiment of the present application;

FIG. 2 is a flow diagram of a method for controlling a lighting effect of a spliced lamp in an embodiment of the present application;

FIG. 3 is a diagram of a graphical user interface of a terminal apparatus in an embodiment of the present application;

FIG. 4 is a flow diagram of determining a motion base point on the basis of a spatial topological graph in an embodiment of the present application;

FIG. 5 is a flow diagram of determining a motion base point on the basis of lighting effect configuration information in an embodiment of the present application;

FIG. 6 is a flow diagram of connecting a terminal apparatus to a spliced lamp in an embodiment of the present application;

FIG. 7 is a flow diagram of generating a spatial topological graph through a modeling space in an embodiment of the present application;

FIG. 8 is a flow diagram of adjusting a viewing angle of a spatial topological graph in an embodiment of the present application;

FIG. 9 is a flow diagram of repositioning a motion base point in an embodiment of the present application;

FIGS. 10 and 11 respectively show examples of interface display effects of two spatial topological graphs that correspond to the same lamp body shape;

FIG. 12 is a flow diagram of generating a lighting effect playing instruction in an embodiment of the present application;

FIG. 13 is a structure diagram of a device for controlling a lighting effect of a spliced lamp in an embodiment of the present application;

FIG. 14 is a structure diagram of a computer apparatus in an embodiment of the present application.

### DETAILED DESCRIPTION

The spliced lamp exemplarily provided in the present application is formed as a plurality of lamp body units adjoin each other and are spliced together. According to different structures of the lamp body units thereof and different splicing relationships thereof, there can be multiple different product shapes. The spliced lamp of the present application is suitable for use as an ambient lamp, can achieve an effect of decorating the spatial atmosphere, and is often mounted in indoor spaces.

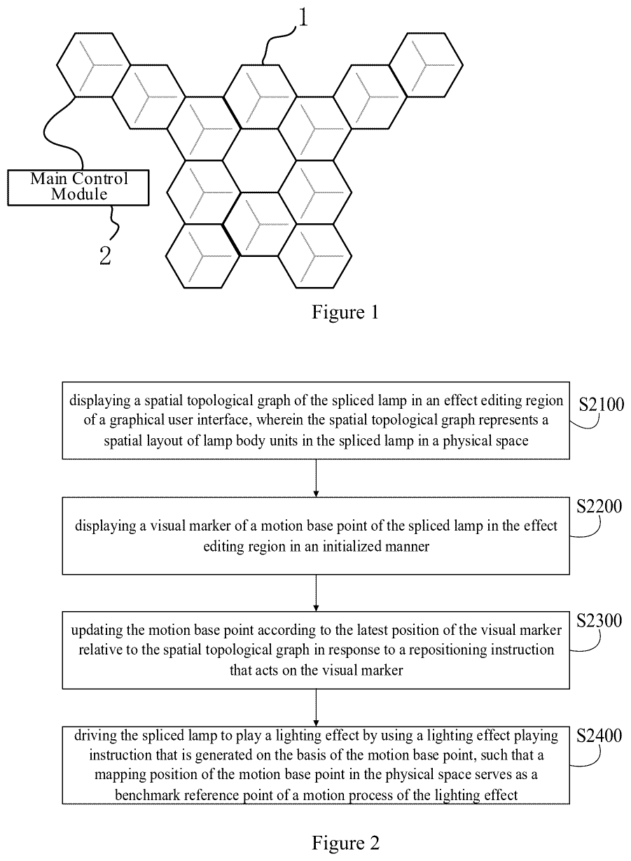

For example, FIG. 1 is a spliced lamp that is formed by splicing a plurality of lamp body units 1 in a regular hexagonal structure, wherein each lamp body unit 1 comprises a plurality of light-emitting units, e.g., the light-emitting units are distributed on edges and rhombic regions of the regular hexagonal structure. Based on this, light-emitting control over the lamp body units 1 at different granularities can be exerted, e.g., the rhombic regions and the edges can be controlled separately, or all the light-emitting units in the lamp body unit 1 can be controlled as a whole.

Each lamp body unit 1 is provided with an amounting interface and an electrical interface that can be spliced with other lamp body units 1. Alternatively, the amounting interface and the electrical interface can be merged into a single electromechanical interface. By splicing different lamp body units 1 in sequence and producing different topological effects, the user can assemble spliced lamps in different shapes.

For the convenience of control, the spliced lamp is generally provided with a main control module 2, which generally comprises a control chip, a communication component, etc.

The control chip can be implemented by using various kinds of embedded chips, such as Bluetooth SoC (System on Chip), WiFi SoC, MCU (Micro Controller Unit), and DSP (Digital Signal Processing), wherein the chips generally comprise a central processing unit and a memory, mainly for storing and executing program instructions to achieve corresponding functions. The communication component can be used for communication with external apparatuses, e.g., it can communicate with various kinds of intelligent terminal apparatuses, such as personal computers and smartphones, such that the user can issue a lighting effect playing instruction to the spliced lamp through the terminal apparatuses.

After receiving the lighting effect playing instruction through the communication component, the control chip correspondingly parses it into a lighting effect signal for controlling the light-emitting units of the spliced lamp, and outputs the lighting effect signal to the lamp body units 1, so as to control the light-emitting units of the lamp body units 1 to collaborate with each other to play a lighting effect.

In some embodiments, the main control module 2 can also be provided with a power adapter, a control panel, and a display screen among others according to needs. The power adapter is mainly used to convert mains power into DC power, so as to supply power to the entire spliced lamp. The control panel generally provides one or more buttons for implementing switch control and the like over the main control module 2. The display screen can be used to display various kinds of control information, so as to cooperate with the buttons in the control panel and support the implementation of human-computer interaction functions. In some embodiments, the control panel can be integrated with the display screen into a single touch-control display screen.

The method for controlling a lighting effect of a spliced lamp in the present application can be implemented as a computer program product, which is mounted and run in a terminal apparatus, so as to provide a human-computer interaction interface for the user; the user completes personalized customization of the lighting effect playing instruction, and then sends the lighting effect playing instruction to the spliced lamp, so as to control the spliced lamp to play a corresponding lighting effect.

Referring to FIG. 2, in one embodiment, the method for controlling a lighting effect of a spliced lamp in the present application comprises:

Step S2100: displaying a spatial topological graph of the spliced lamp in an effect editing region of a graphical user interface, wherein the spatial topological graph represents a spatial layout of lamp body units in the spliced lamp in a physical space;

The spliced lamp is formed as a plurality of lamp body units adjoin each other and are spliced in sequence according to a certain topological relationship in a physical space. Therefore, upon the completion of splicing these lamp body units, one spatial position layout is presented. The spatial position layout of the lamp body units of the spliced lamp can be represented by abstracting the spatial position layout into a data model and then forming a spatial topological graph 4 according to the data model. Formed by splicing in the physical space, the pattern of the spliced lamp can be mapped and transferred to a graphical user interface of a terminal apparatus.

In one embodiment, the splicing of the spliced lamp are done on one plane of the physical space; based on this, the spatial topological graph 4 of the spliced lamp can be defined on the basis of a reference coordinate system that describes a plane. In another embodiment, the splicing of the spliced lamp can also be done on a plurality of planes in the physical space, or on one curved surface or a plurality of different curved surfaces; based on this, a reference coordinate system that describes a three-dimensional space can also be constructed to define the spatial topological graph of the spliced lamp. Whichever reference coordinate system serves as a basis of describing the data model of the spatial topological graph 4, one target viewing angle for display can ultimately be determined for the spatial topological graph. From the target viewing angle, the spatial topological graph can be shown in the graphical user interface.

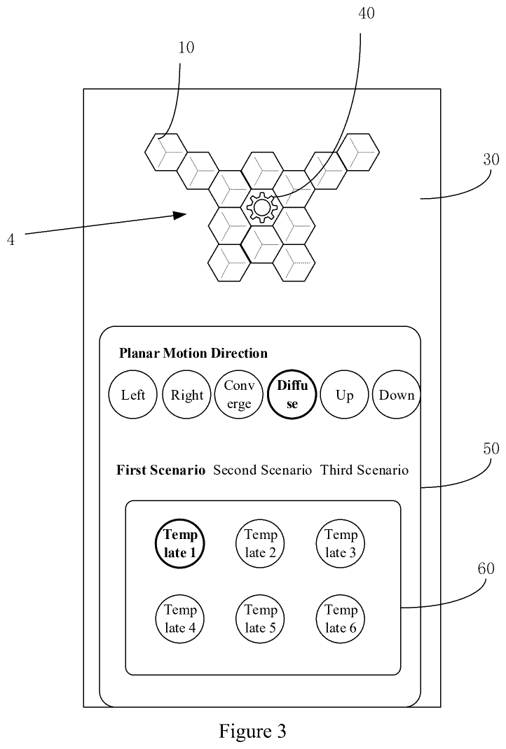

In one embodiment, the graphical user interface of the terminal apparatus can be laid out as shown in FIG. 3. In the graphical user interface, an effect editing region 30 is arranged. The effect editing region 30 presents the spatial topological graph 4 of the spliced lamp from a given target viewing angle. A position marker 10 of each lamp body unit of the spliced lamp and the connection relationship thereof with other lamp body units are clearly showed through the spatial topological graph 4.

Step S2200: displaying a visual marker of a motion base point of the spliced lamp in the effect editing region in an initialized manner;

In essence, a lighting effect is to shape a light-emitting motion process by controlling different light-emitting units to emit light according to the time sequence, thereby showing the motion course of rays, rendering the spatial atmosphere, and constructing an animation effect. Since the light-emitting motion process exists in the lighting effect, in the spliced lamp, starting from different starting points or ending with different ending points will result in different lighting effects. For example, the light-emitting motion process starting from the lower left corner of the spatial position layout of the spliced lamp has a different visual effect from that starting from the geometric center position of the spatial position layout; for the same reason, in the case that the geometric center position serves as a benchmark reference point of the light-emitting motion process, a lighting effect that spreads outward with the benchmark reference point as a starting point has a different visual effect from a light effect that converges inward with the benchmark reference point as an ending point. As can be seen, the motion process of the lighting effect requires one benchmark reference point. The benchmark reference point is mapped on a relative position relationship with the spatial topological graph of the spliced lamp, i.e., a motion base point 40 defined in the present application.

It is not difficult to understand that based on the motion base point or the benchmark reference point, the motion process of the lighting effect not only can start from or end with a “point”, but also can expand from the “point” horizontally or vertically to determine one “line”, which can serve as a benchmark for starting or ending a corresponding motion process.

Therefore, as shown in FIG. 3, the present application arranges one motion base point 40 for the spatial topological graph 4. Regarding the position of the motion base point 40, the position information thereof can be determined according to the reference coordinate system used in the effect editing region 30 of the graphical user interface. The reference coordinate system used in the effect editing region can also be the one that is used when constructing the spatial topological graph. When the reference coordinate system of the effect editing region is a rectangular plane coordinate system, the position of the motion base point can be represented as coordinates that correspond to the horizontal axis and the vertical axis in the rectangular plane coordinate system. Of course, regarding the lamp body units in the spatial topological graph 4, the corresponding position information thereof is also present in the reference coordinate system of the effect editing region 30. Therefore, the relative position relationship between the motion base point and the entire spliced lamp as well as between the motion base point and each lamp body unit in the spliced lamp can be quickly determined on the basis of the reference coordinate system used in the effect editing region 30.

To make the motion base point 40 visible and easy to manipulate, a visual marker (see the gear icon with the reference sign 40) of the motion base point can be provided correspondingly. The visual marker is a control that can be moved in the effect editing region. When the position of the motion base point in the reference coordinate system of the effect editing region is determined, the visual marker of the motion base point can be positioned on the corresponding position for display.

In some embodiments, when the visual marker of the motion base point is displayed in an initialized manner in the effect editing region, one lamp body unit can be selected in the spatial topological graph according to preset business logic, and the position of the selected lamp body unit can be used as the position of the motion base point, so as to display the corresponding visual marker thereof. The selected lamp body unit can be randomly selected in the spatial topological graph; it can also be present on a corner point, such as a lower left corner point, an upper left corner point, a lower right corner point, or an upper right corner point, of the spatial topological graph in the effect editing region; it can also be a center lamp body unit on a geometric center position of the spatial topological graph.

In some other embodiments, the position of the motion base point can be determined on the basis of motion base points that have already been defined in some lighting effect configuration information. The description of the position of the motion base point in the lighting effect configuration information may not be given in plaintext, but it can generally be obtained by converting the time-sequence information described in the lighting effect configuration information on the basis of the correspondence to the lamp body units in the spliced lamp. Specifically, it is determined through comprehensive calculation based on the time-sequence relationship of the lamp body units and the position relationship of the spatial topological graph. The above content is applicable in the case that one piece of lighting effect configuration information has already been applied to the splicing lamp and pre-stored locally in the terminal apparatus, and thus can be directly called for use; alternatively, the lighting effect configuration information can also belong to the lighting effect template selected by the user.

It is not difficult to understand that based on the reference coordinate system of the effect editing region, the motion base point of the present application can be located not only on the position of one lamp body unit in the spatial topological graph, but also on a position external to all the lamp body units in the spatial topological graph. Accordingly, in the physical space where the spliced lamp is located, the motion process of the lighting effect can be to perform motion by using the position of one lamp body unit of the spliced lamp as a benchmark reference point, or by using one position in a peripheral space of the spliced lamp as a benchmark reference point. The benchmark reference point can be determined by determining the motion base point in the effect editing region and mapping it into the physical space where the spliced lamp is located. As can be seen, the positioning range of the motion base point is not limited to the lamp body units of the spliced lamp, but can be expanded to a larger spatial range beyond the spliced lamp. Thus, the lighting effect style of the spliced lamp is enriched, such that the user can modify the lighting effect by flexibly positioning the motion base point.

Step S2300: updating the motion base point according to the latest position of the visual marker relative to the spatial topological graph in response to a repositioning instruction that acts on the visual marker;

Since the visual marker of the motion base point is configured as a movable object, the user is allowed to carry out repositioning. In one embodiment, the user is allowed to input the position information of the motion base point in a corresponding editing region and submit the same to trigger a repositioning instruction, i.e., to input and submit the horizontal and vertical coordinates thereof in the reference coordinate system of the effect editing region to realize the repositioning of the motion base point. In another embodiment, the user is allowed to trigger a repositioning instruction by dragging and releasing the visual marker, so as to realize the repositioning of the motion base point.

It is not difficult to understand that after the motion base point is repositioned by the user, it has new position information. Therefore, in response to the repositioning instruction, the position information of the visual marker of the motion base point relative to the latest position information of the spatial topological graph can be obtained. According to the position information, the position representation of the motion base point can be modified correspondingly. In general, the position information of the visual marker is determined by referencing the coordinate system of the graphical user interface. Due to its correspondence with the reference coordinate system of the effect editing region, the position information can be directly converted into position data relative to the spatial topological graph. For the same reason, it can also be converted into position data of the reference coordinate system used in the modeling space of the spatial topological graph. In similar cases, conversion can be carried out flexibly according to needs. In conclusion, once the visual marker is repositioned, the motion base point, in fact, is also repositioned, and the latest position of the motion base point relative to the spatial topological graph can be determined. By using the relationship, the position data of the motion base point can be redetermined, regardless of whether the position data of the motion base point are stored in plaintext in a corresponding variable or represented in non-plaintext in the light effect configuration information.

Step S2400: driving the spliced lamp to play a lighting effect by using a lighting effect playing instruction that is generated on the basis of the motion base point, such that a mapping position of the motion base point in the physical space serves as a benchmark reference point of a motion process of the lighting effect.

After a base point submission event is triggered by updating the latest position of the motion base point or after the base point submission event is done since the user submits the latest position of the motion base point, a lighting effect playing instruction can be constructed in response to the base point submission event.

The lighting effect playing instruction can be generated by converting the lighting effect configuration information that corresponds to a given lighting effect template. The lighting effect configuration information is a set of instructions that describe how the lamp body units emit light in the motion process of the lighting effect. In one example, in a target motion direction specified by the default motion process, the lighting effect configuration information uses the motion base point as a benchmark, and makes reference to the position relationship between the lamp body units and the motion base point in the spatial topological graph, so as to set lamp body units closer to the motion base point to have earlier working time sequences, and set lamp body units farther from the motion base point to have later working time sequences. In this way, the entire motion process uses the motion base point as a starting point to start showing the lighting effect animation. As can be seen, the relative position relationship between the lamp body units and the motion base point in the spatial topological graph can be converted into the relative time-sequence relationship between the corresponding lamp body units and the benchmark reference point of the physical space in the lighting effect configuration information, so as to realize space-time conversion, and convert and store the repositioning result of the motion base point in the lighting effect configuration information.

The lighting effect template can be selected by the user in advance, and it can also be called when determining the motion base point, or written by the user all by himself or herself. The lighting effect template defines a plurality of lighting effect attributes through the lighting effect configuration information thereof. For example, the lighting effect attributes can include any one or more of lighting effect style, lighting body shape, lighting effect tone, lighting effect sensitivity, planar motion direction, motion base point, motion speed, etc. The lighting effect style is used to define the corresponding style type of the motion process of the lighting effect. The lamp body shape is used to define the control granularity of the light-emitting units in the lamp body units of the spliced lamp. The lighting effect tone is used to define the color combination of the lighting effect. The lighting effect sensitivity is used to define the degree of the response of the lighting effect to external conditions such as the frequency of environmental sound. The planar motion direction is used to define the corresponding target motion direction of the motion process of the lighting effect. The motion base point is used to define the starting point or the ending point of the motion process. The motion speed is used to define the speed of the motion of the lighting effect. As mentioned above, the planar motion direction and the motion base point can be stored as physical data in the lighting effect configuration information, and can also be converted and reflected in the working time-sequence information of the lamp body units of the spliced lamp. Through the relative relationship between the working time-sequence information of the lamp body units, the spatial performance of the motion process of the lighting effect is reflected in the spliced lamp.

As such, based on the lighting effect configuration information, a corresponding lighting effect playing instruction can be encapsulated in a format pre-agreed with the spliced lamp and sent to the spliced lamp. After receiving the lighting effect playing instruction, the control chip of the spliced lamp parses the same to act on the lamp body units, such that the lamp body units work in an orderly manner according to the corresponding working time-sequence information thereof, and produce corresponding effects of the lighting effect attributes, thereby collaborating with each other to complete one or more motion processes and present the entire lighting effect.

It is not difficult to understand that when the spliced lamp present a corresponding lighting effect according to the lighting effect playing instruction, since the motion base point can correspond to one mapping position in the physical space where the spliced lamp is located, the motion process that is exhibited as the lamp body units of the spliced lamp work according to the corresponding working time sequence thereof can be reflected as performing motion by using the mapping position as a benchmark reference point. Since the motion process of the lighting effect is generally arranged to be played on a loop, the effect of playing each motion process on a loop on the basis of the benchmark reference point can be seen. As can be seen, by adjusting the motion reference point in the graphical user interface, the benchmark reference point of the motion process of the lighting effect played in the spliced lamp can be adjusted, and by modifying the motion reference point, one lighting effect template is changed into multiple kinds of motion processes, which derive multiple kinds of lighting effects.

As can be seen from the above embodiments, the present application has technical advantages in multiple aspects, which include, but are not limited to:
firstly, the present application abstracts the spatial position layout of the lamp body units of the spliced lamp into the spatial topological graph, and displays the spatial topological graph in the effect editing region of the graphical user interface; at the same time, the visual marker of the motion base point is provided in the effect editing region for the user to reposition the motion base point, and the lighting effect playing instructions can be can generated in a customized manner by using the repositioned motion base point, such that the user can modify a motion reference point that corresponds to the motion process of the lighting effect according to needs and flexibly define new lighting effects; this not only expands the functions of the spliced lamp product, but also opens up the ability of customizing lighting effects to the user, which can significantly improve the user experience of the spliced lamp;
secondly, the present application realizes the corresponding mapping of the spliced lamp to the spatial position layout in the physical space through the spatial topological graph, and based on this, assists the user in determining the relative position relationship between the motion base point and the spatial topological graph, such that the motion base point not only can be determined on the basis of the correspondence to the physical spatial layout of the spliced lamp, but may not be limited to the correspondence to a specific lamp body unit of the spliced lamp; this amounts to expanding the composition plane of the animation effect of the lighting effect, which can create more abundant lighting effects;
in addition, the present application transforms the course of setting the lighting effect playing instructions from complex programming instructions to convenient human-computer interaction means, thereby improving the application efficiency of the spliced lamp and helping to rapidly promote and apply the spliced lamp in the industry.

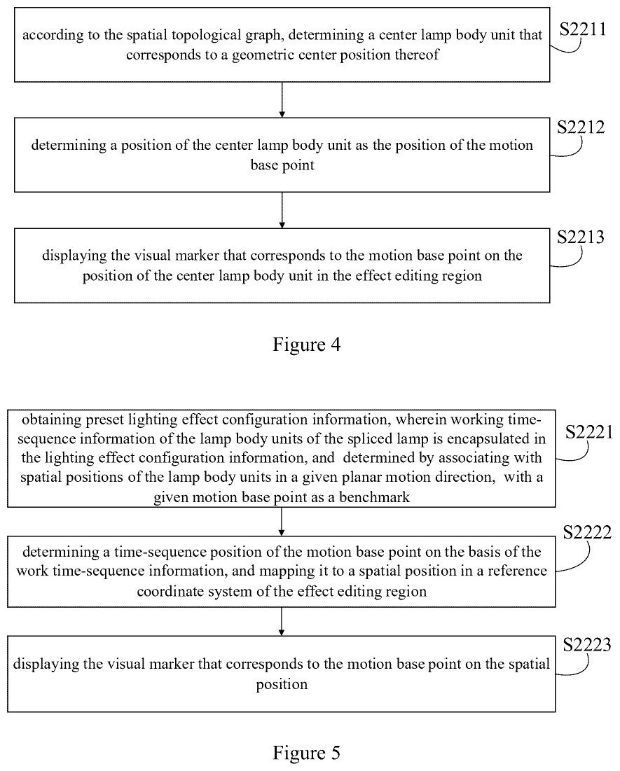

On the basis of any embodiment of the present application, referring to FIG. 4, said displaying a visual marker of a motion base point of the spliced lamp in the effect editing region in an initialized manner comprises:

Step S2211: according to the spatial topological graph, determining a center lamp body unit that corresponds to a geometric center position thereof;

To adapt to the situation of directly generating the motion base point in the spatial topological graph, considering that a plurality of lamp body units are generally laid out in the spliced lamp according to a regular relationship such that the spatial topological graph is generally symmetrical or approximately symmetrical, the center lamp body unit thereof can be determined by finding the geometric center in the spatial topological graph.

In general, for a symmetrical spatial topology graph, it can be spread according to the planar relationship. The symmetric axis of the spatial topology graph can be calculated by using the coordinate position information of the lamp body units. Then, one lamp body unit located on the symmetric axis can be selected as the center lamp body unit.

For an irregular spatial topological graph, by obtaining the geometric center position of the planar region occupied by the spatial topological graph, the lamp body unit closest to the geometric center position can be found as the center lamp body unit that corresponds to the geometric center position.

Step S2212: determining a position of the center lamp body unit as the position of the motion base point;

For the subsequent calculation, the position information of the center lamp body unit, to be specific, the coordinates thereof on the number axes in the relevant reference coordinate system, can be stored as independent variables to represent the position of the motion base point.

Step S2213: displaying the visual marker that corresponds to the motion base point on the position of the center lamp body unit in the effect editing region.

Since the position of the motion base point has been determined, a movable object that represents the motion base point can be called up. The movable object can be displayed as a cursor, and becomes a visual marker. By placing the movable object on the upper layer of the center lamp body unit to display the visual marker, the position of the motion base point can be indicated, which facilitates the user directly manipulating the movable object to reposition the motion base point.

As can be learned from the above embodiments, for the situation that the position information of the motion base point is not provided in the lighting effect template or there is no motion base point position information in the initialization stage, the initialized motion base point thereof can be quickly determined by using the layout relationship of the spatial topological graph, which facilitates the user repositioning the motion base point.

In other embodiments, considering that the geometric shape of the lamp body units determines the topological shape of the spatial topological graph thereof, the motion base point can be determined in the spatial topological graph of the spliced lamp according to the geometric shape of the lamp body units. Specifically speaking, the lamp body units can be in any geometric shape, such as a regular hexagon, triangle, solid hexagon, and Y shape. The manner in any embodiment of the present application is applicable to the lamp body units in the geometric shapes, except the Y-shaped lamp body units, to determine the motion base point thereof from the corresponding spatial topological graph. For the Y-shaped lamp body units, the motion base point can be selected from vertices of one lamp body unit in the spatial topological graph. On exemplary course of determining the motion base point of a spliced lamp that consists of Y-shaped lamp body units is provided as follows, and the course comprises:
firstly, according to the spatial topological graph of the spliced lamp, traversing and accumulating the lamp body units therein to determine the geometric centroid point of the spatial topological graph;
then, calculating the distance between the centroid point and optional points of the lamp body units in the spatial topological graph, and obtaining a set of optional points with the minimum distance;
further, according to the set of optional points with the minimum distance, sorting the optional points from smallest to largest according to the horizontal or vertical coordinate of the optional points in the reference coordinate system, and selecting a set of optional points with the largest horizontal or vertical coordinate;
finally, determining whether the number of the optional points in the finally determined set is 1; if the number is 1, using the unique optional point as the motion base point for the spliced lamp; if the number is larger than 1, sorting the optional points from smallest to largest according to the other coordinate axis (the vertical or horizontal coordinate) of the optional points in the set, and then using the optional point ranked in the middle as the motion base point.

As can be seen from the above embodiments, given the feature that the Y-shaped lamp body units have a structure of branches, according to the particular business logic, the motion reference point of the spliced lamp that consists of such lamp body units can better match the topological relationship of the spatial topological graph thereof, thereby quickly and effectively determining the motion reference point.

On the basis of any embodiment of the present application, referring to FIG. 5, said displaying a visual marker of a motion base point of the spliced lamp in the effect editing region in an initialized manner comprises:

Step S2221: obtaining preset lighting effect configuration information, wherein working time-sequence information of the lamp body units of the spliced lamp is encapsulated in the lighting effect configuration information, and determined by associating with spatial positions of the lamp body units in a given planar motion direction, with a given motion base point as a benchmark;

The motion base point can also be determined on the basis of pre-configured lighting effect configuration information. The lighting effect configuration information can be that for generating a lighting effect playing instruction when the lighting effect playing instruction needed to be applied in the spliced lamp last time, and after it was used last time, the lighting effect configuration information is associated with a feature marker of the spliced lamp and stored locally in the terminal apparatus for reuse. The lighting effect configuration information can also be that corresponding to a target lighting effect template specified for the spliced lamp.

As mentioned above, the working time-sequence information of the lamp body units of the spliced lamp is encapsulated in the lighting effect configuration information. There is a sequential relationship among working time sequences of the lamp body units. The sequential relationship among the working time sequences corresponds to the position relationship in the spatial topological graph. Specifically speaking, with the motion base point as a benchmark, the lighting effect configuration information converts the order of the spatial positions of the lamp body units relative to the motion base point into the order of the time sequences in the motion process according to the planar motion direction specified by the motion process of the lighting effect as used. For example, in a spatial topological graph with a circular layout, it is determined that the center lamp body unit at the center of the circle is the motion base point, and it is stipulated that the planar motion direction of the motion process of the lighting effect thereof is outward diffusion; at this time, in the lighting effect configuration information, the working time-sequence information of the center lamp body unit can be represented as 0 seconds, the working time-sequence information of the first circle of lamp body units close to the center lamp body unit can be represented as 0.5 seconds, the working time-sequence information of the second circle of lamp body units close to the first circle of lamp body units can be represented as 1.0 second, and so on. By stipulating the working time-sequence information of the lamp body units, when the spliced lamp emits light, the lamp body units are controlled to carry out light-emitting display by means of the time difference calculated between the corresponding working time sequences thereof, so as to collaborate with each other to present the motion process of the lighting effect.

Step S2222: determining a time-sequence position of the motion base point on the basis of the work time-sequence information, and mapping it to a spatial position in a reference coordinate system of the effect editing region;

According to the above example, it is not difficult to understand that after determining the planar motion direction, by using the time difference between the working time-sequence information of different lamp body units, the working time-sequence information of the motion base point that corresponds to the center lamp body unit can also be deduced backward. By mapping these working time sequences into the spatial topological graph, it is not difficult to deduce backward the position of the motion base point relative to the lighting effect configuration information. Even if the motion base point is outside the spatial topological graph, the spatial position thereof can still be determined on the basis of the reference coordinate system of the effect editing region.

For example, it is assumed that: the spatial topological graph as a whole presents a ring-shaped layout; it is stipulated that the planar motion direction is outward diffusion; the motion base point is located at the center of the ring-shaped layout outside the spatial topological graph; the working time-sequence information thereof should be represented as 0 seconds, which is not explicitly provided in the lighting effect configuration information since there is no corresponding lamp body unit; however, as the lamp body units of the spliced lamp have already used the center as the motion base point, the working time-sequence information of the lamp body units in different circles is set in a manner that the equal time difference is, e.g., 0.5 seconds; in light of the above assumption, the time difference can be used to determine that a region is occupied by one lamp body unit every 0.5 seconds; based on this, the specific spatial position where the working time-sequence information is represented as 0 seconds in the reference coordinate system of the effect editing region can be deduced backward, i.e., the position of the motion base point.

Step S2223: displaying the visual marker that corresponds to the motion base point on the spatial position.

For the same reason, after determining the spatial position of the motion base point in the effect editing region, the movable object that corresponds to the visual marker can be called and displayed in the spatial position to facilitate the manipulation of the user.

As can be learned from the above embodiments, for the existing lighting effect configuration information, the working time-sequence information of the lamp body units of the spliced lamp as represented therein can be used to deduce backward the coordinate information of the motion base point in the effect editing region, and determine the spatial position thereof in the effect editing region; then, the spatial position is marked with a visual marker, which facilitates the user calling the lighting effect configuration information that was used in the spliced lamp in the past; the visual marker of the motion base point of the lighting effect configuration information is precisely shown in the spatial topological graph of the spliced lamp, which facilitates the user manipulating the motion base point of the lighting effect used in spliced lamp in a relatively real-time and intuitive manner, thereby realizing WYSIWYG

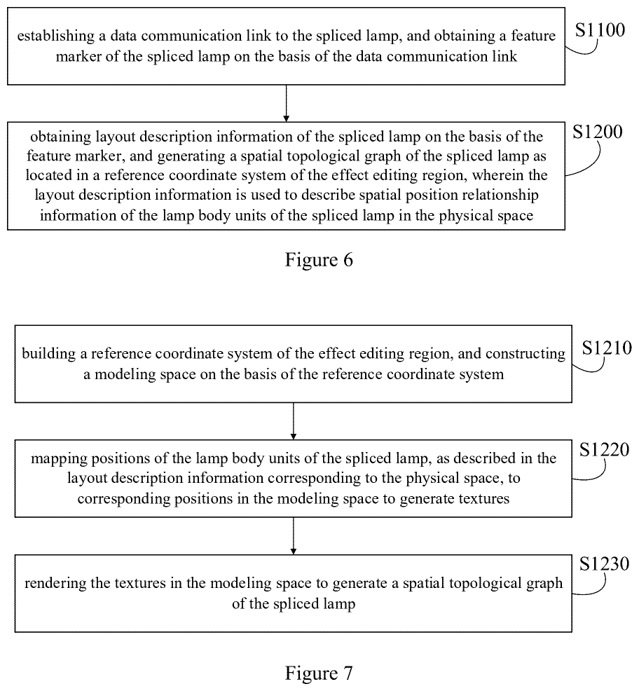

On the basis of any embodiment of the present application, referring to FIG. 6, before displaying a visual marker of a motion base point of the spliced lamp in the effect editing region in an initialized manner, the method comprises:

Step S1100: establishing a data communication link to the spliced lamp, and obtaining a feature marker of the spliced lamp on the basis of the data communication link;

As mentioned above, a communication component is arranged in the spliced lamp, and the terminal apparatus can establish a data communication link with the communication component to perform bidirectional communication. For example, the terminal apparatus can obtain a feature marker of the spliced lamp, perform initialized binding, associate with the feature marker, and store the lighting effect configuration information used in the spliced lamp.

Step S1200: obtaining layout description information of the spliced lamp on the basis of the feature marker, and generating a spatial topological graph of the spliced lamp as located in a reference coordinate system of the effect editing region, wherein the layout description information is used to describe spatial position relationship information of the lamp body units of the spliced lamp in the physical space.

After obtaining the feature marker, the terminal apparatus can also read serial data of the lamp body units of the spliced lamp through the data communication link, determine layout description information that corresponds to the spatial layout of the lamp body units on the basis of serial communication protocol, associate with the feature marker, and store the layout description information locally.

Visually speaking, since each lamp body unit can be connected to one or more other lamp body units, in reality, each lamp body unit has edge connection relationship information. In the course of configuring the spliced lamp, the edge connection relationship information can be determined. For example, an edge connection is established between an interface A′ of a lamp body unit A and an interface B′ of a lamp body unit B; as such, the relationship information can be represented as data, and the layout description information consists of these data; it is not difficult to understand that the layout description information describes the spatial position relationship information of the lamp body units of the spliced lamp in the physical space.

Since the edge connection relationship information of the lamp body units of the spliced lamp has already been provided in the layout description information, the layout graph of the lamp body units can be constructed according to the edge connection relationship information, so as to obtain the spatial topological graph.

In one embodiment, considering that spliced lamp is generally laid out on a plane, the positions of graphic markers of the lamp body units can be displayed and determined in two-dimensional space according to the edge connection relationship information of the lamp body units, so as to splice the spatial topology of the spliced lamp and display it in the effect editing region correspondingly.

In another embodiment, the physical space where the spliced lamp is located can also be modeled in three-dimensional space. Then, in the modeling space, a spatial topological graph is constructed by using the edge connection relationship information of the lamp body units, and the spatial topological graph is shown in the effect editing region from the best viewing angle.

As can be learned from the above embodiments, the spatial topological graph can be generated on the basis of the actual layout relationship of the lamp body units of the spliced lamp in the physical space, such that the spatial topological graph shown in the effect editing region can accurately correspond to the spatial layout of the spliced lamp in the physical space, thereby ensuring that it is more precise to determine the motion base point subsequently.

On the basis of any embodiment of the present application, referring to FIG. 7, said obtaining layout description information of the spliced lamp on the basis of the feature marker, and generating a spatial topological graph of the spliced lamp as located in a reference coordinate system of the effect editing region comprises:

Step S1210: building a reference coordinate system of the effect editing region, and constructing a modeling space on the basis of the reference coordinate system;

The effect editing region of the graphical user interface of the terminal apparatus is a two-dimensional plane with its own rectangular plane coordinate system. As one dimension is expanded on the basis of the rectangular plane coordinate system, a three-dimensional reference coordinate system can be obtained. The three-dimensional reference coordinate system can also correspond to or directly act as the reference coordinate system for generating the modeling space of the spatial topological graph. Therefore, a modeling space can be constructed through the reference coordinate system.

Step S1220: mapping positions of the lamp body units of the spliced lamp, as described in the layout description information corresponding to the physical space, to corresponding positions in the modeling space to generate corresponding textures;

To generate the spatial topological graph of the spliced lamp in the modeling space, the position of the lamp body units in the physical space as represented by the edge connection relationship information in the layout description information of the spliced lamp can be mapped to the corresponding positions in the modeling space, and then the textures of the lamp body units can be generated on the corresponding positions. Adaptively, when the layout description information describes the positions and edge connection relationship information of the lamp body units in the physical space, coordinates of the third dimension can be added on the basis of the horizontal and vertical coordinates to meet needs of three-dimensional modeling.

Step S1230: rendering the textures in the modeling space to generate a spatial topological graph of the spliced lamp.

Finally, by rendering the textures that correspond to the lamp body units in the modeling space and displaying them on the screen, the spatial topological graph that corresponds to the spliced lamp, as well as the markers of the lamp body units in the spatial topological graph, can be obtained in the effect editing region.

Based on the modeling space, the spatial topological graph is implemented, which facilitates adjusting the viewing angle of the spatial topological graph in the effect editing region according to needs. Subsequently, the lighting effect can be simulated by applying lighting effect configuration information on the basis of the spatial topological graph. In this way, for a spliced lamp with a complex spatial shape, the lighting effect performances of the spliced lamp can be intuitively observed in the graphical user interface of the terminal apparatus.

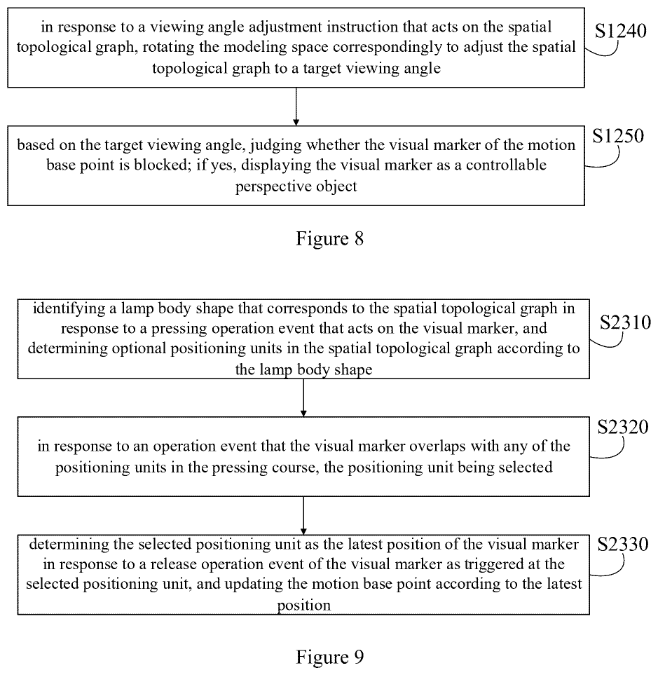

On the basis of any embodiment of the present application, referring to FIG. 8, after rendering the textures in the modeling space to generate a spatial topological graph of the spliced lamp, the method comprises:

Step S1240: in response to a viewing angle adjustment instruction that acts on the spatial topological graph, rotating the modeling space correspondingly to adjust the spatial topological graph to a target viewing angle;

After rendering the spatial topological graph of the spliced lamp in the modeling space, the user can adjust the viewing angle of the modeling space that corresponds to the spatial topological graph. Through operations such as touching and dragging, the spatial topological graph can be switched from the current viewing angle to the target viewing angle. In this way, for a spatial topological graph that occupies multiple planes or curved surfaces, the target region can be highlighted by adjusting the viewing angle.

Step S1250: based on the target viewing angle, judging whether the visual marker of the motion base point is blocked; if yes, displaying the visual marker as a controllable perspective object.

In the modeling space of the spatial topology, the motion base point is determined. When the viewing angle where the motion base point is located is made invisible by rotating the modeling space, the motion base point will theoretically be blocked. In this case, it can be judged whether the motion base point is blocked relative to the current target viewing angle through the position information of the visual marker of the motion base point in the modeling space. If it is determined that the motion base point is blocked, the visual marker will be displayed as a perspective object on the original position, and it is ensured that the visual marker is controllable. In this way, the user can directly drag and drop the visual marker onto the current position of the target viewing angle, such that the motion base point is switched onto a certain position in the current target viewing angle.

As can be learned from the above embodiments, after switching the viewing angle of the spatial topological graph, the visual marker that corresponds to the motion base point can be seen through and manipulated, and the user can manipulate the same motion base point between different viewing angles without complex operations, which is convenient and efficient.

On the basis of any embodiment of the present application, referring to FIG. 9, said updating the motion base point according to the latest position of the visual marker relative to the spatial topological graph in response to a repositioning instruction that acts on the visual marker comprises:

Step S2310: identifying a lamp body shape that corresponds to the spatial topological graph in response to a pressing operation event that acts on the visual marker, and determining optional positioning units in the spatial topological graph according to the lamp body shape;

The lamp body units can have different shapes, and one lamp body unit may comprise a plurality of independently controllable light-emitting units. Depending on the difference in the control granularity of the lighting effect of the spliced lamp, the corresponding relationship between the motion base point and the lamp body units can be concretized into the control granularity of the light-emitting units in the lamp body units. Therefore, when setting the motion base point that corresponds to the spatial topological graph of the spliced lamp, to facilitate the user selecting the specific light-emitting units in each lamp body unit in the spatial topological graph, the motion base point can be set by adapting to different lamp body shapes and guiding the user to select the corresponding position of the specific light-emitting units. Based on this, when the user presses the visual marker and triggers a pressing operation event of the visual marker, the terminal apparatus can obtain the type information of the lamp body shape of the spliced lamp according to the feature marker of the spliced lamp, and determine a plurality of positioning units from the spatial topological graph according to the specific lamp body shape. Each positioning unit corresponds to one of the light-emitting units in one lamp body unit.

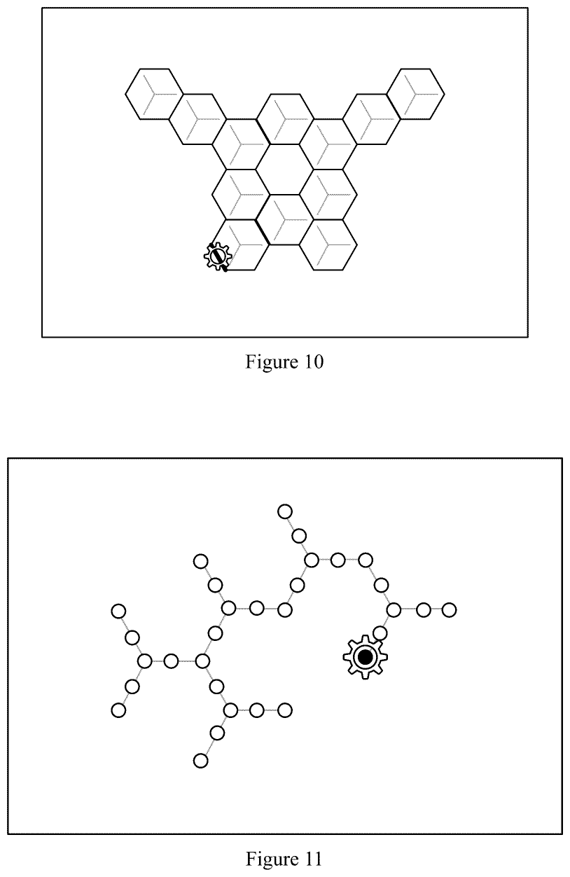

In the interface shown in FIG. 10, since the lamp body units are in a regular hexagonal structure, independently controllable light-emitting units can be arranged on edges and rhombic regions thereof. Therefore, the edges and the rhombic regions can be determined as the positioning units. In the interface shown in FIG. 11, since the lamp body units are in a Y-shaped structure, which comprises a plurality of branches, independently controlled light-emitting units are arranged on endpoints and midpoints of each branch. Therefore, the endpoints and the midpoints can be set as the positioning units.

In one embodiment, to facilitate the user identifying the positioning units, on the positions that correspond to the positioning units in the spatial topological graph, symbolic markers can be used to display the positions of the positioning units, as shown by the circles in FIG. 11.

Step S2320: in response to an operation event that the visual marker overlaps with any of the positioning units in the pressing course, the positioning unit being selected;

When the user presses the visual marker and moves it on a positioning unit, the visual marker basically overlaps with the positioning unit in terms of the position. In this case, it can be considered that the user has selected this positioning unit.

In one embodiment, the positioning unit selected by the user can be highlighted. For example, in FIGS. 10 and 11, FIG. 10 displays the positioning unit selected by the user in a bold line, and FIG. 11 displays the positioning unit selected by the user in a solid dot.

Step S2330: determining the selected positioning unit as the latest position of the visual marker in response to a release operation event of the visual marker as triggered at the selected positioning unit, and updating the motion base point according to the latest position.

After the user determines the selected positioning unit, the visual marker can be released to trigger the release operation event. Then, according to the latest position of the visual marker, i.e., the position information of the selected positioning unit, the position information of the motion base point is updated to achieve the repositioning of the motion base point.

As can be seen from the above embodiments, distinguishing the specific shape of the lamp body units of the spliced lamps and setting the corresponding positioning units thereof as options of the user in the course of repositioning the motion base point can perform the function of effectively corresponding to the specific positions in the spliced lamp, and especially when performing different visual processing in response to different events in the specific links of the operation course of the user, can play a better role in control and guidance, thereby making it more accurate for the user to reposition the motion base point.

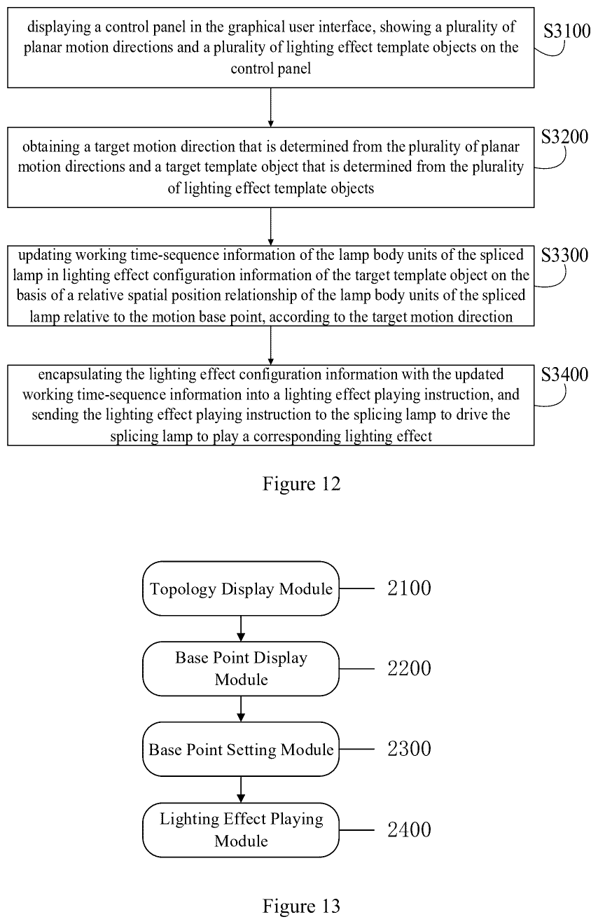

On the basis of any embodiment of the present application, referring to FIG. 12, before driving the spliced lamp to play a lighting effect by using a lighting effect playing instruction that is generated on the basis of the motion base point, the method comprises:

Step S3100: displaying a control panel in the graphical user interface, showing a plurality of planar motion directions and a plurality of lighting effect template objects on the control panel;

As shown in FIG. 3, in the graphical user interface of the terminal apparatus, specifically, one control panel 50 can be displayed below the effect editing region 30, such that the user can customize the lighting effect configuration information through the control panel 50, thereby modifying the lighting effect playing instruction.

In one embodiment, the control panel is configured in one layer and can be popped up from the graphical user interface; it is superimposed and located on the lower side of the spatial topological graph 4 in the effect editing region 30 to avoid blocking the spatial topological graph 4; moreover, the entire content in the control panel 50 can be traversed through a slide-down operation.

To facilitate the customization of the lighting effect used in the spliced lamp through the control panel 50, a plurality of lighting effect templates can be provided in advance. These lighting effect templates can come from a server, and are classified onto different scenario pages 60 by scenario. Entrances to the scenario pages are arranged in the control panel 50, and one of the scenario pages is set as the default scenario page. In the default scenario page, various lighting effect template objects are displayed, such that the user can choose one lighting effect template therefrom. Different lighting effect templates pre-define corresponding light effect configuration information thereof. Moreover, as mentioned above, the lighting effect configuration information defines the planar motion direction and motion base point of the corresponding lighting effect. When the user selects one lighting effect template object in one of the scenario pages, the selected lighting effect template object becomes the target template object, and the lighting effect configuration information of the corresponding lighting effect template will be applied in the spatial topological graph of the effect editing region. The motion base point of the corresponding lighting effect can be previewed in the effect editing region.

Of course, the currently applied lighting effect template can also be the lighting effect template used in the spliced lamp last time, and it can serve as the target lighting effect template selected by the user. The position of the motion base point in the effect editing region is updated according to the lighting effect configuration information of the lighting effect template used last time.

The motion process used by each lighting effect generally involves selecting different planar motion directions to control the motion manner of the motion process thereof relative to the motion base point. For this purpose, one attribute editing region for selecting the planar motion direction can be further provided in the control panel; in the attribute editing region, a plurality of optional options are displayed, each corresponding to one planar motion direction, and corresponding icons are displayed.

When the user needs to modify the planar motion direction of the currently applied lighting effect template, he or she can select one of the optional options in the corresponding attribute editing region, such that the planar motion direction corresponding to the selected optional option becomes the target motion direction.

When the user needs to modify the motion base point of the currently applied lighting effect template, he or she can reposition the motion base point in the effect editing region.

Step S3200: obtaining a target motion direction that is determined from the plurality of planar motion directions and a target template object that is determined from the plurality of lighting effect template objects;

When determining the target template object by selecting one lighting effect template object in the scenario page, the user finishes setting the target motion direction by making selections in the attribute editing region. Moreover, if necessary, after finishing repositioning the motion base point by repositioning the visual marker in the effect editing region, the data that correspond to these modifications made by the user can be used to modify the lighting effect configuration information of the target template object, so as to complete the customization of the lighting effect.

Step S3300: updating working time-sequence information of the lamp body units of the spliced lamp in lighting effect configuration information of the target template object on the basis of a relative spatial position relationship of the lamp body units of the spliced lamp relative to the motion base point according to the target motion direction;

The target motion direction determines the spatial position sequence of the lamp body units in the spliced lamp relative to the motion base point. Therefore, according to the relative spatial position relationship of the lamp body units in the spliced lamp relative to the motion base point, in the aforementioned manner, the working time-sequence information of the lamp body units in the lighting effect configuration information of the target template object can be updated, such that the updated working time-sequence relationship of the lamp body units matches the motion process defined by the target motion direction, thereby realizing the modification of the lighting effect configuration information.

Step S3400: encapsulating the lighting effect configuration information with the updated working time-sequence information into a lighting effect playing instruction, and sending the lighting effect playing instruction to the splicing lamp to drive the splicing lamp to play a corresponding lighting effect.

After the user finishes setting the target lighting effect template, which results in adaptive modification to the working time-sequence information in the light effect configuration information thereof according to the set planar motion direction and the set motion base point, he or she can submit an application instruction. In response to the application instruction, the terminal apparatus encapsulates and converts the light effect configuration information of the target lighting effect template into a lighting effect playing instruction in the format pre-agreed with the spliced lamp, and then sends the lighting effect playing instruction to the spliced lamp. After receiving the lighting effect playing instruction, the spliced lamp parses it correspondingly, converts it into a lighting effect control signal, and transmits the lighting effect control signal to each lamp body unit to control each lamp body unit to emit light according to the corresponding working time sequence thereof, so as to cooperates with other lamp body units in association with the working time sequence to play the corresponding lighting effect.

As can be learned from the above embodiments, in the presence of a plurality of lighting effect templates provided to the user and based on the selected target lighting effect template, the user can customize new lighting effects by repositioning the motion base point and resetting the planar motion direction, thereby enriching the implementation forms of the lighting effects and expanding the diversity of the lighting effects of the spliced lamp.

Referring to FIG. 13, in another embodiment of the present application, there is further provided a device for controlling a lighting effect of a spliced lamp, which comprises a topology display module 2100, a base point display module 2200, a base point setting module 2300, and a lighting effect playing module 2400, wherein: the topology display module 2100 is configured to display a spatial topological graph of the spliced lamp in an effect editing region of a graphical user interface, wherein the spatial topological graph represents a spatial position layout of lamp body units of the spliced lamp in a physical space; the base point display module 2200 is configured to display a visual marker of a motion base point of the spliced lamp in the effect editing region in an initialized manner; the base point setting module 2300 is configured to update the motion base point according to the latest position of the visual marker relative to the spatial topological graph in response to a repositioning instruction that acts on the visual marker; the lighting effect playing module 2400 is configured to drive the spliced lamp to play a lighting effect by using a lighting effect playing instruction that is generated on the basis of the motion base point, such that a mapping position of the motion base point in the physical space serves as a benchmark reference point of a motion process of the lighting effect.

On the basis of any embodiment of the present application, the base point display module 2200 comprises: a center determining unit, configured to, according to the spatial topological graph, determine a center lamp body unit that corresponds to a geometric center position thereof; a base point mapping unit, configured to determine a position of the center lamp body unit as the position of the motion base point; a marker display unit, configured to display the visual marker that corresponds to the motion base point on the position of the center lamp body unit in the effect editing region.

On the basis of any embodiment of the present application, the base point display module 2200 comprises: a pre-storing calling unit, configured to obtain preset lighting effect configuration information, wherein working time-sequence information of the lamp body units of the spliced lamp is encapsulated in the lighting effect configuration information, and determined by associating with spatial positions of the lamp body units in a given planar motion direction, with a given motion base point as a benchmark; a space-time mapping unit, configured to determine a time-sequence position of the motion base point according to the work time-sequence information, and map the time-sequence position to the spatial position in a reference coordinate system of the effect editing region; a marker display unit, configured to display the visual marker that corresponds to the motion base point on the spatial position.

On the basis of any embodiment of the present application, the device for controlling a lighting effect of a spliced lamp in the present application further comprises: a communication connection module, configured to establish a data communication link to the spliced lamp, and obtaining a feature marker of the spliced lamp on the basis of the data communication link; a mapping composition module, configured to obtain layout description information of the spliced lamp on the basis of the feature marker, and generate a spatial topological graph of the spliced lamp as located in a reference coordinate system of the effect editing region, wherein the layout description information is used to describe spatial position relationship information of the lamp body units of the spliced lamp in the physical space.

On the basis of any embodiment of the present application, the mapping composition module comprises: a spatial virtual unit, configured to build a reference coordinate system of the effect editing region, and construct a modeling space on the basis of the reference coordinate system; a position mapping unit, configured to map positions of the lamp body units of the spliced lamp, as described in the layout description information corresponding to the physical space, to corresponding positions in the modeling space to generate corresponding textures; an image rendering unit, configured to render the textures in the modeling space to generate a spatial topological graph of the spliced lamp.

On the basis of any embodiment of the present application, the device for controlling a lighting effect of a spliced lamp in the present application further comprises: a viewing angle adjusting unit, configured to, in response to a viewing angle adjustment instruction that acts on the spatial topological graph, rotate the modeling space correspondingly to adjust the spatial topological graph to a target viewing angle; a marker adjusting unit, configured to judge whether the visual marker of the motion base point is blocked on the basis of the target viewing angle, and if yes, display the visual marker as a controllable perspective object.

On the basis of any embodiment of the present application, the base point setting module 2300 comprises: a press response unit, configured to identify a lamp body shape that corresponds to the spatial topological graph in response to a pressing operation event that acts on the visual marker, and determine optional positioning units in the spatial topological graph according to the lamp body shape; a highlight display unit, configured to, in response to an operation event that the visual marker overlaps with any of the positioning units in the pressing course, cause the positioning unit to be selected; a release update unit, configured to determine the selected positioning unit as the latest position of the visual marker in response to a release operation event of the visual marker as triggered at the selected positioning unit, and update the motion base point according to the latest position.

On the basis of any embodiment of the present application, the device for controlling a lighting effect of a spliced lamp in the present application further comprises: a panel display module, configured to display a control panel in the graphical user interface, and show a plurality of planar motion directions and a plurality of lighting effect template objects on the control panel; a data acquisition module, configured to obtain a target motion direction that is determined from the plurality of planar motion directions and a target template object that is determined from the plurality of lighting effect template objects; a time-sequence reorganization module, configured to update the working time-sequence information of each lamp body unit of the spliced lamp in the lighting effect configuration information of the target template object based on the relative spatial position relationship of each lamp body unit of the spliced lamp relative to the motion base point according to the target motion direction; an instruction encapsulation module, configured to encapsulate the lighting effect configuration information of the updated working time-sequence information into a lighting effect playing instruction, and send the lighting effect playing instruction to the splicing lamp to drive the splicing lamp to play a corresponding lighting effect.

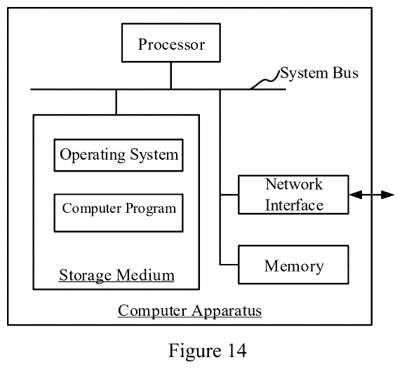

On the basis of any embodiment of the present application, referring to FIG. 14, in another embodiment of the present application, there is further provided an apparatus for controlling a lighting effect of a spliced lamp, which can be implemented as a computer apparatus. FIG. 14 is an internal structure diagram of a computer apparatus. The computer apparatus comprises a processor, a computer-readable storage medium, a memory, and a network interface that are connected through a system bus. Wherein, an operating system, a database, and computer-readable instructions are stored in the computer-readable storage medium of the computer apparatus; control information sequences can be stored in the database; when the computer-readable instructions are executed by the processor, the processor can be made to implement a method for controlling a lighting effect of a spliced lamp. The processor of the computer apparatus is used to provide computing and control capabilities in support of the operation of the entire computer apparatus. Computer-readable instructions can be stored in the memory of the computer apparatus, and when the computer-readable instructions are executed by the processor, the processor can be made to execute the method for controlling a lighting effect of a spliced lamp in the present application. The network interface of the computer apparatus is used for connection and communication with a terminal. Persons skilled in the art can understand that the structure shown in FIG. 14 is only a block diagram of some structures relevant to the solution of the present application, and does not constitute a limitation on the computer apparatus to which the present application is applied. The specific computer apparatus can comprise more or fewer components than shown in the figure, or be combined with certain components, or have different component arrangements.

In the present manner of implementation, the processor is used to execute specific functions of the modules and sub-modules thereof in FIG. 13, and program codes and various kinds of data required to execute the modules or the sub-modules. The network interface is used for data transmission to a user terminal or a server. In the present manner of implementation, the program codes and data required to execute all the modules/sub-modules in the device for controlling a lighting effect of a spliced lamp in the present application are stored in the memory. The server can call the program codes and data of the server to execute the functions of all the sub-modules.

The present application further provides a storage medium in which computer-readable instructions are stored; when the computer-readable instructions are executed by one or more processors, said one or more processors are made to implement steps of the method for controlling a lighting effect of a spliced lamp in any embodiment of the present application.

The present application further provides a computer program product, comprising computer programs/instructions; when executed by a processor, the computer programs/instructions implement steps of the method for controlling a lighting effect of a spliced lamp in any embodiment of the present application.

In conclusion, the present application allows the user to customize the motion base point of the lighting effect of the spliced lamp. With the help of the spatial topological graph of the spliced lamp, the motion base point can be positioned in a more accurate manner within a wider range, so as to expand the practical functions of the spliced lamp.

What is claimed is:

1. A method for controlling a lighting effect of a spliced lamp, comprising:
displaying a spatial topological graph of the spliced lamp in an effect editing region of a graphical user interface, wherein the spatial topological graph represents a spatial position layout of lamp body units of the spliced lamp in a physical space;
displaying a visual marker of a motion base point of the spliced lamp in the effect editing region in an initialized manner, wherein the motion base point indicates a benchmark reference point of a motion process of the lighting effect on the spatial topological graph through the visual marker;
updating the motion base point according to the latest position of the visual marker relative to the spatial topological graph, in response to a repositioning instruction that acts on the visual marker;
driving the spliced lamp to play a lighting effect by using a lighting effect playing instruction that is generated on the basis of the motion base point, such that a mapping position of the motion base point in the physical space serves as a benchmark reference point of a motion process of the lighting effect.

2. The method for controlling a lighting effect of a spliced lamp according to claim 1, wherein said displaying a visual marker of a motion base point of the spliced lamp in the effect editing region in an initialized manner comprises: selecting one lamp body unit in the spatial topological graph according to preset business logic, using a position of the selected lamp body unit as the position of the motion base point, and displaying a corresponding visual marker on the position of the motion base point.

3. The method for controlling a lighting effect of a spliced lamp according to claim 2, wherein the selected lamp body unit is a randomly selected lamp body unit in the spatial topological graph, or a lamp body unit on a lower left corner point, an upper left corner point, a lower right corner point, or an upper right corner point of the spatial topological graph in the effect editing region, or a center lamp body unit that corresponds to a geometric center position of the spatial topological graph.

4. The method for controlling a lighting effect of a spliced lamp according to claim 1, wherein said displaying a visual marker of a motion base point of the spliced lamp in the effect editing region in an initialized manner comprises:
according to the spatial topological graph, determining a center lamp body unit that corresponds to a geometric center position of the spatial topological graph;
determining a position of the center lamp body unit as the position of the motion base point;
displaying the visual marker that corresponds to the motion base point on the position of the center lamp body unit in the effect editing region.

5. The method for controlling a lighting effect of a spliced lamp according to claim 1, wherein said displaying a visual marker of a motion base point of the spliced lamp in the effect editing region in an initialized manner comprises:
obtaining preset lighting effect configuration information, wherein working time-sequence information of the lamp body units of the spliced lamp is encapsulated in the lighting effect configuration information, and the working time-sequence information is determined by using a given motion base point as a benchmark and associating with spatial positions of the lamp body units in a given planar motion direction;
determining a time-sequence position of the motion base point on the basis of the work time-sequence information, and mapping the time-sequence position to a spatial position in a reference coordinate system of the effect editing region;
displaying the visual marker that corresponds to the motion base point on the spatial position.

6. The method for controlling a lighting effect of a spliced lamp according to claim 1, wherein before displaying a visual marker of a motion base point of the spliced lamp in the effect editing region in an initialized manner, the method comprises:
establishing a data communication link to the spliced lamp, and obtaining a feature marker of the spliced lamp on the basis of the data communication link;
obtaining layout description information of the spliced lamp on the basis of the feature marker, and generating a spatial topological graph of the spliced lamp as located in a reference coordinate system of the effect editing region, wherein the layout description information is used to describe spatial position relationship information of the lamp body units of the spliced lamp in the physical space.

7. The method for controlling a lighting effect of a spliced lamp according to claim 6, wherein said obtaining layout description information of the spliced lamp on the basis of the feature marker, and generating a spatial topological graph of the spliced lamp as located in a reference coordinate system of the effect editing region comprises:
building a reference coordinate system of the effect editing region, and constructing a modeling space on the basis of the reference coordinate system;
mapping positions of the lamp body units of the spliced lamp, as described in the layout description information corresponding to the physical space, to corresponding positions in the modeling space to generate corresponding textures;
rendering the textures in the modeling space to generate a spatial topological graph of the spliced lamp.

8. The method for controlling a lighting effect of a spliced lamp according to claim 1, wherein said updating the motion base point according to the latest position of the visual marker relative to the spatial topological graph in response to a repositioning instruction that acts on the visual marker comprises:
identifying a lamp body shape that corresponds to the spatial topological graph in response to a pressing operation event that acts on the visual marker, and determining optional positioning units in the spatial topological graph according to the lamp body shape;
in response to an operation event that the visual marker overlaps with any of the positioning units in the pressing course, the positioning unit being selected;
determining the selected positioning unit as the latest position of the visual marker in response to a release operation event of the visual marker as triggered at the selected positioning unit, and updating the motion base point according to the latest position.

9. The method for controlling the lighting effect of spliced lamps according to claim 1, wherein before driving the spliced lamp to play a lighting effect by using a lighting effect playing instruction that is generated on the basis of the motion base point, the method comprises:
displaying a control panel in the graphical user interface, and showing a plurality of planar motion directions and a plurality of lighting effect template objects on the control panel;
obtaining a target motion direction that is determined from the plurality of planar motion directions and a target template object that is determined from the plurality of lighting effect template objects;
updating working time-sequence information of the lamp body units of the spliced lamp in lighting effect configuration information of the target template object on the basis of a relative spatial position relationship of the lamp body units of the spliced lamp relative to the motion base point, according to the target motion direction;
encapsulating the lighting effect configuration information with the updated working time-sequence information into a lighting effect playing instruction, and sending the lighting effect playing instruction to the splicing lamp to drive the splicing lamp to play a corresponding lighting effect.

10. The method for controlling a lighting effect of a spliced lamp according to claim 1, wherein the spliced lamp is formed as a plurality of lamp body units adjoin each other and are spliced in sequence in the physical space according to a certain topological relationship; the plurality of lamp body units are spliced on one or more planes of the physical space.

11. The method for controlling a lighting effect of a spliced lamp according to claim 1, wherein the spliced lamp is formed as a plurality of lamp body units adjoin each other and are spliced in sequence in the physical space according to a certain topological relationship; the plurality of lamp body units are spliced on one or more curved surfaces of the physical space.

12. The method for controlling a lighting effect of a splicing lamp according to claim 1, wherein the motion base point is located on a position of one lamp body unit in the spatial topological graph, or on a position external to all lamp body units in the spatial topological graph.

13. The method for controlling a light effect of a spliced lamp according to claim 12, wherein the motion process of the lighting effect is to perform motion by using the position of one lamp body unit of the spliced lamp as the benchmark reference point or by using one position in a peripheral space of the spliced lamp as the benchmark reference point.

14. The method for controlling a light effect of a spliced lamp according to claim 1, wherein the visual marker of the motion base point is configured as a movable object that is allowed to be repositioned by a user.

15. The method for controlling a light effect of a spliced lamp according to claim 1, wherein the lighting effect playing instruction is generated by converting the lighting effect configuration information that corresponds to a given lighting effect template; the lighting effect configuration information is an instruction set for describing light-emitting manners of the lamp body units in the motion process.

16. The method for controlling a light effect of a spliced lamp according to claim 15, wherein the lighting effect template is selected by a user in advance, called when determining the motion base point, or written by the user.

17. The method for controlling a light effect of a spliced lamp according to claim 15, wherein the lighting effect template defines lighting effect attributes through the lighting effect configuration information, and the lighting effect attributes include any one or more of lighting effect style, lamp body shape, lighting effect tone, lighting effect sensitivity, planar motion direction, motion base point, and motion speed.

18. A device for controlling a lighting effect of a spliced lamp, comprising:
a topology display module, configured to display a spatial topological graph of the spliced lamp in an effect editing region of a graphical user interface, wherein the spatial topological graph represents a spatial position layout of lamp body units of the spliced lamp in a physical space;
a base point display module, configured to display a visual marker of a motion base point of the spliced lamp in the effect editing region in an initialized manner, wherein the motion base point indicates a benchmark reference point of a motion process of the lighting effect on the spatial topological graph through the visual marker;
a base point setting module, configured to update the motion base point according to the latest position of the visual marker relative to the spatial topological graph, in response to a repositioning instruction that acts on the visual marker;
a lighting effect playing module, configured to drive the spliced lamp to play a lighting effect by using a lighting effect playing instruction that is generated on the basis of the motion base point, such that a mapping position of the motion base point in the physical space serves as a benchmark reference point of a motion process of the lighting effect.

19. An apparatus for controlling a lighting effect of a spliced lamp, comprising a central processing unit and a memory, wherein the central processing unit is used to call and run a computer program stored in the memory to execute steps of the method for controlling a lighting effect of a spliced lamp according to claim 1.

20. A non-transitory computer-readable storage medium, wherein computer programs in the form of computer-readable instructions are stored in the computer-readable storage medium, and when called and run by a computer, the computer programs execute steps of the method for controlling a lighting effect of a spliced lamp according to claim 1.
